(19) United States
(12) Patent Application Publication
(10) Pub. No.: US 2009/0245899 A1
(43) Pub. Date: Oct. 1, 2009

(54) BELT FIXING DEVICE AND IMAGE FORMING APPARATUS

(75) Inventor: Makoto SATO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/396,912

(22) Filed: Mar. 3, 2009

(30) Foreign Application Priority Data
Mar. 27, 2008 (JP) 2008-082293

(51) Int. Cl. G03G 15/20

(52) U.S. Cl. 399/329

(57) ABSTRACT

A belt fixing device includes a fixing roller, a heating roller, a fixing belt stretched between the fixing roller and the heating roller, and a pressing roller pressing the fixing roller through the fixing belt. In at least one end portion of the heating roller in an axial direction, a ring regulating skewed movement of the fixing belt toward an axial end, a belt tension adjusting unit regulating tension of the fixing belt, and a ring separating/contacting unit operating in conjunction with the belt tension adjusting unit to separate the ring from the fixing belt or to bring the ring into contact with the fixing belt are provided.

### BACKGROUND

1. Technical Field

The invention relates to a belt fixing device, which can prevent an end portion of a belt from being damaged, and an image forming apparatus.

2. Related Art

Electrophotographic image forming apparatuses use a belt fixing device as a fixing device for a transfer medium. In such a belt fixing device, a belt is a thin endless belt that is manufactured by coating silicon rubber on a base material, such as stainless steel, nickel, or the like, and forming a heat-resistant release layer having good heat resistance and releasability against toner.

In the belt fixing device, a measure to prevent a fixing belt from being damaged becomes an issue. For example, Japanese Patent No. 3,711,717 discloses a configuration in which an abutting type ring against skewed movement of a fixing belt is provided at one axial end of a tension roller, which gives tension to a fixing roller. In this example, the amount of thermal expansion of the fixing belt is smaller than that of the tension roller (heating roller) on which the ring is provided.

In the configuration of Japanese Patent No. 3,711,717, during cooling, the amount of thermal contraction of the heating roller becomes larger than that of the fixing belt. Accordingly, a guide ring strongly presses the end portion of the fixing belt in an axial direction of the heating roller. Although the fixing belt is pressed in the axial direction of the heating roller by the guide, it cannot be easily “shifted” in the axial direction due to a frictional force between the fixing belt and the heating roller. For this reason, large stress is applied to the end portion of the fixing belt, and accordingly ruffles (wrinkles) may be formed in the fixing belt. When this happens, if the heating roller is driven again, two ruffles that are formed in the fixing belt are moved and connected to each other. As a result, in the worst case, the fixing belt may be damaged (cracked).

In order to reduce the frictional force between the fixing belt and the heating roller, it is effective to coat the heating roller with fluorine or to decrease tension of the fixing belt. However, in order to stably drive the fixing belt crept by fixing heat, predetermined tension needs to be applied, and actually the above-described measure has an insufficient effect.

### SUMMARY

An advantage of some aspects of the invention is that it provides a belt fixing device, which can prevent an end portion of a fixing belt from being damaged, and an image forming apparatus.

According to another aspect of the invention, a belt fixing device includes a fixing roller, a heating roller, a fixing belt stretched between the fixing roller and the heating roller, and a pressing roller pressing the fixing roller through the fixing belt. In at least one end portion of the heating roller in an axial direction, a ring regulating skewed movement of the fixing belt toward an axial end, a belt tension adjusting unit regulating tension of the fixing belt, and a ring separating/contacting unit operating in conjunction with the belt tension adjusting unit to separate the ring from the fixing belt or to bring the ring into contact with the fixing belt are provided.

In the belt fixing device according to the aspect of the invention, when the belt tension adjusting unit reduces tension of the fixing belt, the ring separating/contacting unit may separate the ring from the fixing belt.

In the belt fixing device according to the aspect of the invention, the belt tension adjusting unit may adjust an intercenter distance between the fixing roller and the heating roller by an electromagnetic driving unit and a spring unit.

In the belt fixing device according to the aspect of the invention, the ring separating/contacting unit may include a first cam and a second cam provided at at least one axial end of the heating roller, and each of the first and second cams may have a long-distance portion and a short-distance portion in the axial direction of the heating roller.

In the belt fixing device according to the aspect of the invention, a temperature detection unit for detecting the temperature of the fixing belt at the time of stoppage may be provided, and the temperature detected by the temperature detection unit may be stored in a storage unit.

In the belt fixing device according to the aspect of the invention, the belt tension adjusting unit may be controlled by a control unit on the basis of the temperature of the fixing belt at the time of stoppage stored in the storage unit.

In the belt fixing device according to the aspect of the invention, a series of control operation to separate the ring in conjunction with reduction in tension of the fixing belt and to then restore tension of the fixing belt in conjunction with an operation to bring the ring into contact with the fixing belt may be repeatedly performed multiple times.

According to another aspect of the invention, an image forming apparatus image forming units each having at least one of a charging unit, an exposure unit, a developing unit, and a transfer unit around a photosensitive member, and the belt fixing device according to the aspect of the invention. The image forming apparatus transfers an image formed on each of the image forming units to a recording medium, thereby performing image formation.

### BRIEF DESCRIPTION OF THE DRAWINGS

The invention will be described with reference to the accompanying drawings, wherein like numbers reference like elements.

FIGS. 1A to 1C are explanatory views illustrating an embodiment of the invention.

FIGS. 2A to 2C are explanatory views illustrating an embodiment of the invention.

FIG. 3 is an explanatory view illustrating an embodiment of the invention.

FIG. 4 is an explanatory view illustrating an embodiment of the invention.

FIG. 5 is an explanatory view illustrating an embodiment of the invention.

FIG. 6 is an explanatory view illustrating an embodiment of the invention.

FIG. 7 is an explanatory view illustrating an embodiment of the invention.

FIG. 8 is a characteristic diagram illustrating an embodiment of the invention.

FIG. 9 is an explanatory view illustrating an embodiment of the invention.

FIG. 10 is an explanatory view illustrating an embodiment of the invention.

FIG. 11 is a block diagram illustrating an embodiment of the invention.

FIG. 12 is schematic sectional view illustrating the overall configuration of an example of an image forming apparatus using an electrophotography process according to the invention.

### DESCRIPTION OF EXEMPLARY EMBODIMENTS

An embodiment of the invention will be described with reference to the drawings. FIG. 4 is an explanatory view illustrating an example of a belt fixing device. In FIG. 4, a fixing belt 34 is stretched between a fixing roller 31 and a heating roller 35, which function as belt tension rollers. A fixing heater 36 is provided inside the heating roller 35. The temperature of the fixing belt 34 is detected by using a temperature detection device 37, such as a thermistor. As the fixing heater 36, for example, a halogen lamp is used. An overheating prevention device 38 is provided near the heating roller 35. The heating roller 35 is given a pressing force Ft by a belt tension spring 33a to apply tension to the fixing belt 34. The pressing roller 32 is given a pressing force Fp by a pressing spring 33.

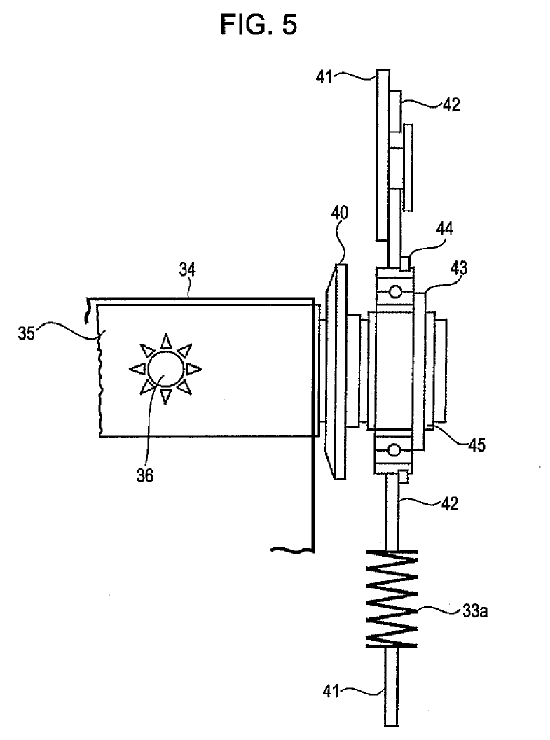

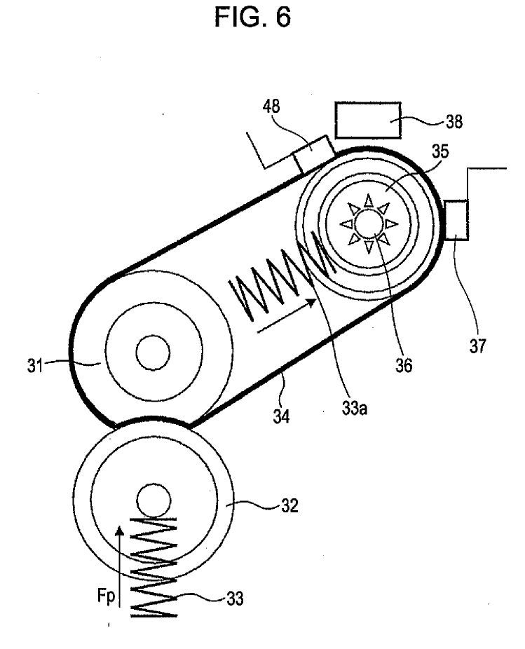

FIG. 5 is an explanatory view illustrating a fixing method of the heating roller 35 and the fixing belt 34 to a fixing unit in the belt fixing device. In FIG. 5, a bearing 44 fixing the heating roller 35 is inserted into a tension plate 42, and the tension plate 42 is fixed to be movable in one direction with respect to a fixing frame 41. The tension plate 42 is urged in one direction by the belt tension spring 33a, one end of which is fixed to the fixing frame 41. With this configuration, the fixing belt 34 is stretched between the heating roller 35 and the fixing roller 31 under substantially uniform tension. The bearing 44 has sealed grease in terms of heat resistance, and since the surface temperature of the heating roller 35 reaches an extremely high temperature, it is inserted into a rotational shaft (flange) of the heating roller 35 through a heat-insulating bush 43. A guide ring 40 is designed so as to be rotatable and movable in a thrust direction in at least one end portion of the heating roller 35 toward the rotational shaft, that is, so as to be spaced from the rotational shaft of the heating roller 35. The guide ring 40 functions as a ring regulating skewed movement of the fixing belt 34 toward an axial end of the heating roller 35.

Respective members of the belt fixing device will be further described in detail. As described with reference to FIG. 4, the fixing belt 34 is stretched between the fixing roller 31, which is positioned in the fixing unit, and the heating roller 35, which is urged to be movable in a predetermined direction by the belt tension spring 33a. In terms of the belt layout, an intermediate roller may be provided between the fixing roller 31 and the heating roller 35, and the fixing belt 34 may be stretched around three or more rollers.

The fixing roller 31 is configured to have a large heat capacity in order to ensure a nip width. A heat source is provided in the heating roller 35 having a small heat capacity and heat is transferred to the fixing roller 31 through the fixing belt 34, thereby reducing a warm-up time. In the example of FIG. 4, the heating roller 35 has the internal fixing heater 36 serving as a heat source, but an electromagnetic induction heating (IH) type heat source may be provided inside and outside the heating roller 35.

A temperature detection device 37, such as a thermistor or the like, is disposed so as to be in contact with or close to the surface of the fixing belt 34 wound around the heating roller 35 to detect the surface temperature. The fixing heater 36 serving as a heat source is turned on/off on the basis of the detection result of the temperature detection device 37, to thereby perform temperature control of the heating roller 35 that should be maintained at a desired temperature. An overheating prevention device 38 is provided near the heating roller 35 to prevent fire when abnormality is produced.

The pressing roller 32 is pressed against the fixing roller 31 by the pressing spring 33 with the fixing belt 34 sandwiched therebetween. The pressing roller 32 and the fixing roller 31 are formed of elastic members, and a nip is formed. In the example of FIG. 4, with respect to hardness of the members, the relationship is established that the pressing roller has hardness larger than that of the fixing roller, and, as shown in FIG. 4, a downward nip is formed. In a high-speed machine, a heat source may be provided in the fixing roller 31 or the pressing roller 32. With respect to drive input, in many cases, the fixing roller 31 is connected to the outside through a gear or the like to function as a driving roller, but it may be connected to the pressing roller 32 and driven.

Next, materials of the members to be used for the belt fixing device will be described. In the embodiment of the invention, the fixing belt 34 is a three-layered belt in which an elastic layer made of silicon rubber is formed on an Ni electroformed member, and a release layer made of fluorine resin is further formed. In order to reduce the warm-up time, the heating roller 35 is provided separately from the fixing roller 31. For this reason, it is necessary to transfer heat from the heating roller 35 to the nip portion through the fixing belt 34, and as a base material of the fixing belt 34, a metal belt having a comparatively large heat capacity is used. This is because a resin belt made of polyimide or the like has a small heat capacity, and heat is dissipated to the nip portion, which causes a large heat loss.

The fixing belt 34 has a seamless metal belt, and as described above, Ni electroforming is applied. When a stainless belt from among the metal belts is used, it is necessary to reduce a curvature due to the hardness of the belt, and to increase the diameter of the roller and the size of the fixing device. The elastic layer of the fixing belt is provided in order to increase adhesion to an image surface and to ensure image quality. For the elastic layer, silicon rubber is used because of excellent heat resistance.

In the fixing belt 34, the release layer made of fluorine resin is provided in order to release toner molten in the nip portion from the surface of the belt. As the material of the release layer, perfluoroalkoxy alkane resin (PFA) is used. In the related art, as described in Japanese Patent No. 3,711,717, silicon oil is coated on the elastic layer made of silicon rubber, to thereby ensuring releasability. However, since silicon oil is stuck to the sheet, writability is deteriorated, and in recent years, there is little case in which silicon oil is used.

In order to reduce the warm-up time, a thin metal roller having a small heat capacity is used as the heating roller 35. For the thin metal roller, in order to make the temperature distribution in the axial direction uniform, aluminum having high thermal conductivity is used. In order to improve sheet releasability of the image surface, the fixing roller 31 forms a downward nip, as shown in FIG. 4, or a horizontal nip. As the fixing roller 31 that has hardness smaller than that of the pressing roller 32, a sponge roller or the like is used. As the pressing roller 32, in many cases, a rubber roller is used. In terms of heat resistance, for the pressing roller 32, silicon rubber is used. In order to prevent contamination of the rear surface of the sheet and to improve surface releasability, a fluorine resin layer is formed on the surface of the pressing roller 32.

In a normal state, the fixing belt 34 is conveyed between the fixing roller 31 and the heating roller 35 without being skewed in the axial direction of the roller. However, for exampler when the two rollers (the fixing roller 31 and the heating roller 35) with the fixing belt 34 stretched therebetween is not in parallel, the fixing belt 34 is skewed in the axial direction of the roller. The fixing belt 34 being skewed rotates at least one tension roller of the fixing roller 31 and the heating roller 35 backward, and the fixing belt 34 moves in an opposite direction to forward rotation.

FIG. 6 is an explanatory view illustrating the embodiment of the invention. The same parts as those shown in FIG. 4 are represented by the same reference numerals, and detailed descriptions thereof will be omitted. In FIG. 6, a sensor 48 is provided to check the surface temperature distribution of the fixing belt 34. An operation to prevent the fixing belt 34 from being damaged due to thermal stress is performed on the basis of the surface temperature distribution of the fixing belt 34 at the time of stoppage checked by the sensor 48, as described below.

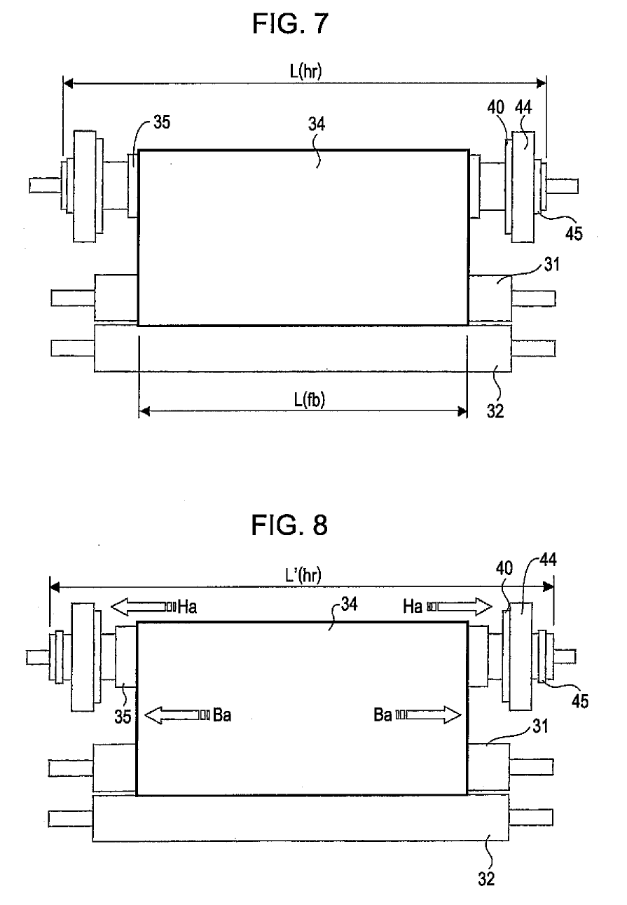

Next, a description will be provided for stress, which is applied to the end portion of the fixing belt 34, with reference to explanatory views of FIGS. 7 to 10. FIG. 7 illustrates the length L(hr) of the heating roller 35 and the length L(fb) of the fixing belt 34 when being cooled. FIG. 8 illustrates the length L′(hr) of the heating roller 35 when being heated. In the configuration of FIGS. 7 and 8, aluminum having high thermal conductivity is used such that the temperature distribution of the heating roller 35 in the axial direction is made uniform when a small size of sheet passes. As the fixing belt 34, an Ni electroformed belt which is maintained at a temperature from a heating section to the nip portion is used.

If the heater is turned on, the heating roller 35 starts to expand. In FIG. 8, Ha and Ha represent thermal expansion toward both ends of the heating roller 35 in the axial direction. When the heating roller 35 reaches a target temperature, the heating roller 35 is extended by ΔL(hr), and thus the total length of the heating roller 35 is as follows.

L′(hr)=L(hr)+ΔL(hr)

The relationship of the extension amount according to a difference in linear expansion coefficient between the heating roller 35 and the fixing belt 34 will be described. In the embodiment of the invention, stress due to thermal contraction is generated when the following relationship is established with respect to the linear expansion coefficient.

Heating Roller>Fixing Belt

As the heating roller 35 is heated, heat is transferred to the fixing belt 34 wound around the heating roller 35, and the fixing belt 34 starts to thermally expand. In FIG. 8, Ba and Ba represent thermal expansion of the fixing belt 34 toward both ends of the roller. When the fixing belt 34 reaches a target temperature, the fixing belt 34 is extended by ΔL(fb) due to thermal expansion, and thus the total length of the fixing belt 34 is as follows.

L′(fb)=L(fb)+ΔL(fb)

In the configuration of FIG. 8, an example of ΔL(hr) when aluminum is used for the heating roller 35 will be described. Referring to Table 1, the linear expansion coefficient αa of aluminum is 24×10⁻⁶/° C. Let Δt be a difference in temperature of the heating roller 35 between when the heating roller 35 is cooled and when the heating roller 35 is heated. In this case, ΔL(hr) is as follows.

ΔL(hr)=L(hr)×Δt×αa

TABLE 1
Linear Expansion Coefficient by Material (×10⁻⁶/° C.)

| | |
|---|---|
| Aluminum (5000 series) | 24 |
| Iron | 11 |
| Nickel | 15 |
| Si rubber | 25 to 40 |
| PFA | 120 |
| PI | 54 |

Therefore, when the heating roller 35 is heated from 20° C. to 180° C., the following relationship is established.

ΔL(hr)=L(hr)×(180−20)×24×10⁻⁶

Let the linear expansion coefficient be αb, and let the difference in temperature of the heating roller 35 between when the heating roller 35 is cooled and when the heating roller 35 is heated be Δt, then the extension amount ΔL(fb) of the fixing belt 34 is as follows.

ΔL(fb)=L(fb)×Δt×αb

When Ni electroforming is used for the fixing belt 34, since the linear expansion coefficient αb is 15×10⁻⁶/° C. from Table 1, ΔL(fb) is as follows.

ΔL(fb)=L(fb)×(180−20)×15×10⁻⁶

As described above, when L(hr) and L(fb) are the same, the extension amount of the heating roller becomes larger.

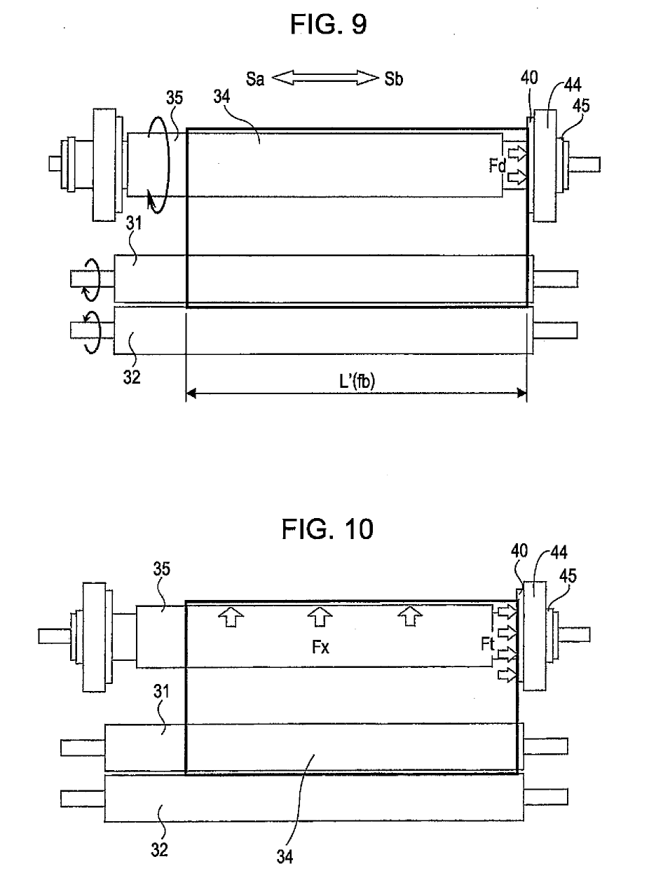

In the belt fixing device, for example, a pair of rollers (in this example, the fixing roller 31 and the heating roller 35 functioning as tension rollers) with the fixing belt 34 stretched therebetween are not in parallel due to a variation in part precision of the fixing frame 41. For this reason, when the tension rollers are rotated, the fixing belt 34 leans in the axial direction of the roller (skewed movement). In FIG. 9, the fixing belt 34 leans in a right direction of the drawing along the axis of the roller. In this case, the same force as the screw rule is applied to the heating roller 35 in contact with the inner surface of the fixing belt 34, and the heating roller 35 leans in a left direction of the drawing along the axis of the roller. Sa denotes the movement direction of the heating roller 35, and Sb denotes the movement direction of the fixing belt 34. As described with reference to FIG. 5, the heating roller 35 is provided in the fixing unit by the bearing 44 so as not to be separated in the axial direction.

The heating roller 35 is configured so as not to move in the axial direction anymore if a snap ring 45, which is provided at the right end of FIG. 9, comes into contact with the bearing 44. For this reason, when the heating roller 35 rotates, stress Fd when the fixing belt 34 tries to move is given to the guide ring 40, which is provided on the right side of the drawing. The guide ring 40 is formed of a material having strength, heat resistance, and slidability. Therefore, destruction strength of the guide ring 40 and the fixing belt 34 can be increased, and abrasion in an engaging end portion of the fixing belt 34 can be minimized.

Thermal contraction of the fixing belt 34 and the heating roller 35 after printing is completed will be described with reference to FIG. 10. Immediately after the heating roller 35 stops to rotate and the fixing heater is turned off, the fixing belt 34 and the heating roller 35 having been heated start to thermally contact. The timing at which the heating roller 35 stops to rotate and the fixing heater 36 is turned off or the order in which the heating roller 35 stops to rotate and the fixing heater 36 is turned off may be appropriately selected. The heating roller 35 is restrained by the snap ring 45 and the bearing 44 on the right side of FIG. 10, and thermal contraction of the heating roller 35 acts on the restrained portion. The inner surface of the fixing belt 34 and the outer peripheral surface of the heating roller 35 are strongly held by a force Fx=belt tension×stiction force therebetween. In this state, if the heating roller 35 thermally contracts toward the restrained portion, the fixing belt 34 also moves toward the restrained portion in the same manner.

The above-described thermal expansion and thermal contraction of the heating roller 35 are reversible operations. For this reason, when the heating roller 35 and the fixing belt 34 having the same length thermally contract, the contraction amount of the heating roller 35 becomes larger than the contraction amount of the fixing belt 34. A difference in the contraction amount between the heating roller 35 and the fixing belt 34 is given as stress Ft on the right side of FIG. 10, such that the fixing belt 34 bites into the guide ring 40. If stress Ft is repeatedly given, shear destruction occurs in the end portion of the fixing belt 34.

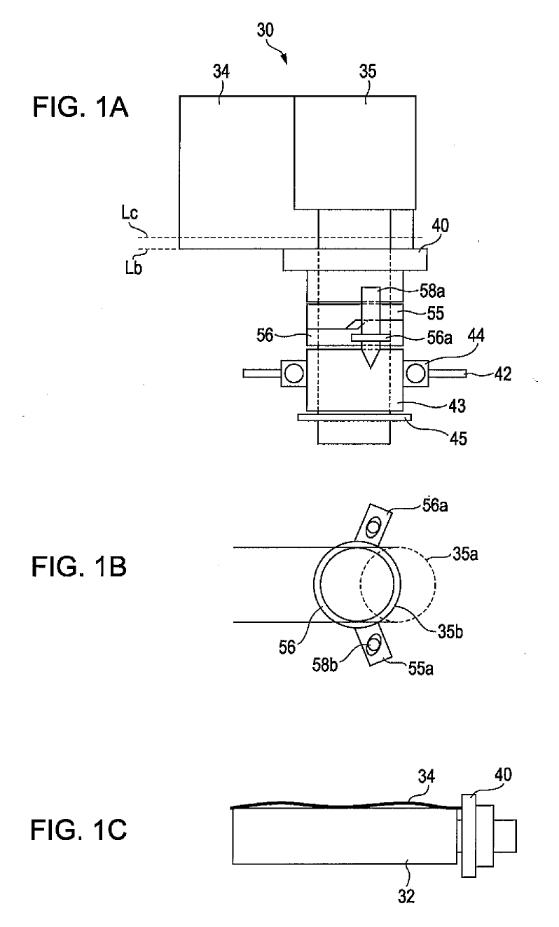

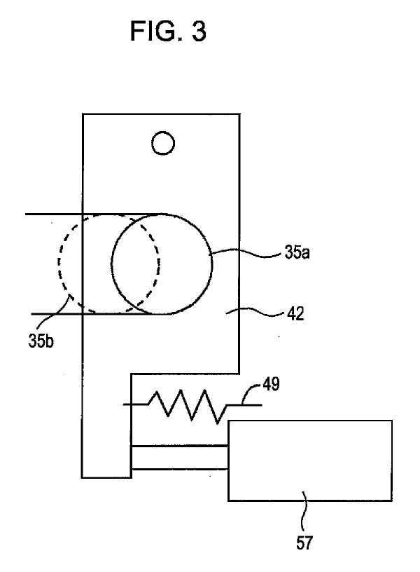

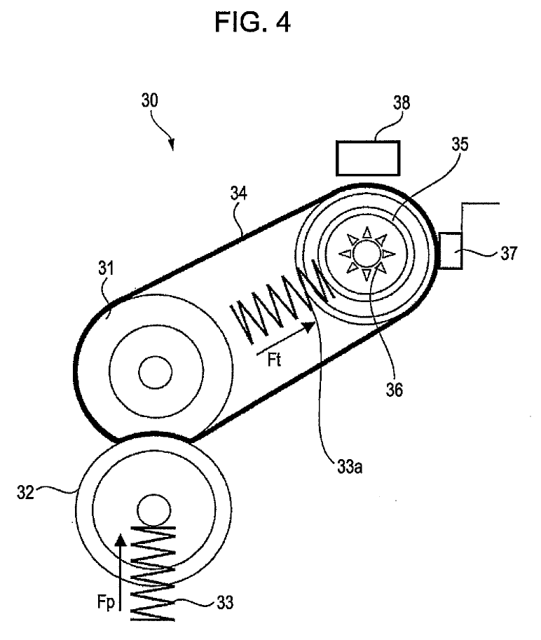

FIGS. 1A to 3 are explanatory views illustrating the embodiment of the invention. FIG. 3 shows an example of a tension release mechanism of the fixing belt 34. In FIG. 3, reference numeral 42 denotes the tension plate described with reference to FIG. 5. In a state where tension of the fixing belt 34 is released, a pressing force is given to a solenoid 57 in a direction perpendicular to the axis of the heating roller 35. One axial end of the heating roller 35 is present at a position indicated by a dashed line 35b. Reference numeral 49 denotes a tension spring. In a normal state, the spring force of the tension spring 49 acts such that one axial end of the heating roller 35 is present at a position indicated by a solid line 35a.

When thermal stress is applied to the fixing belt 34 due to an increase in temperature of the heating roller 35, the solenoid 57 operates to release the spring force of the tension spring 49, to thereby move the tension plate 42 in the left direction of the drawing. For this reason, one axial end of the heating roller 35 moves to a position indicated by the dashed line 35b. Accordingly, the intercenter distance between the fixing roller 31 and the heating roller 35 described with reference to FIG. 4 is shortened, and tension of the fixing belt 34 is reduced. As described above, the solenoid (electromagnetic driving unit) 57 and the tension spring (spring unit) 49 function as a belt tension adjusting unit.

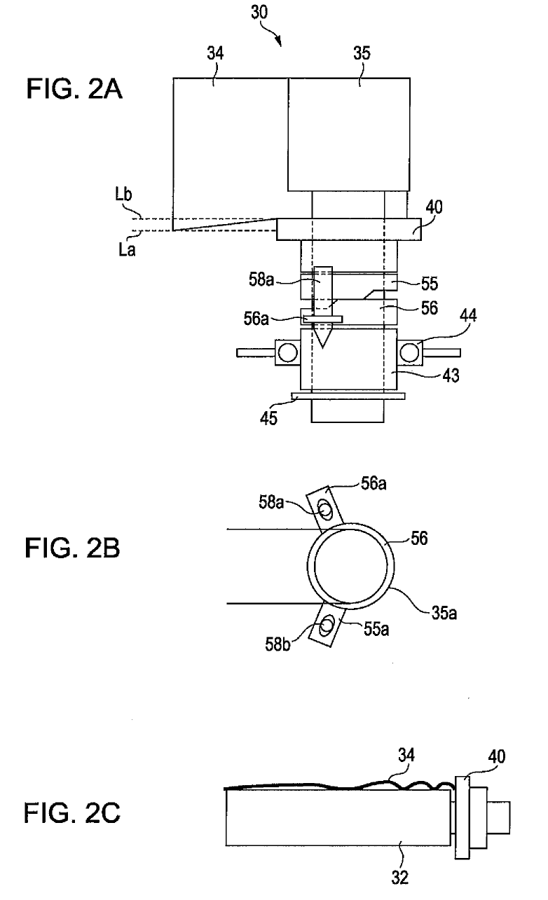

Next, a separating mechanism for separating the guide ring 40 shown in FIG. 5 from one end of the fixing belt 34 will be described with reference to the explanatory views of FIGS. 1A to 2C. FIGS. 2A to 2C illustrate a case in which the fixing belt 34 is stretched. FIG. 2A illustrates the arrangement of members at one axial end of the heating roller 35. One end portion of the fixing belt 34 is pressed by the guide ring 40 and deformed. A line Lb denotes a position where one end portion of the fixing belt 34 is in contact with the guide ring 40, and a line La denotes a position where the deformed end portion of the fixing belt 34 is present.

Reference numerals 55 and 56 denote a first cam and a second cam that separate the guide ring 40 from the fixing belt 34 and bring the guide ring 40 into contact with the fixing belt 34, respectively. As shown in FIG. 2B, the first cam 55 and the second cam 56 are provided with levers 55a and 56a and pins 58a and 58b, respectively. In FIG. 2A, only the lever 56a and the pin 58a are shown. In FIG. 2B, reference numeral 35a denotes the position of an axial end of the heating roller 35 that overlaps the position of an outer end portion of the second cam 56, and corresponds to the axial end position shown in FIG. 3.

A distance by which the first cam 55 and the second cam 56 overlap each other in the axial direction of the heating roller 35 is set to be long in a first state. That is, long-distance portions of the first cam 55 and the second cam 56 in the axial direction of the heating roller overlap each other. FIG. 2C is a diagram schematically illustrating the relationship between the fixing belt 34 and the guide ring 40 in the state of FIG. 2A. One end portion of the fixing belt 34 is pressed by the guide ring 40, and accordingly a “wrinkle” is generated.

FIGS. 1A to 1C illustrate a state where the fixing belt 34 is not stretched. In FIG. 1A, concave portions of the first cam 55 and the second cam 56 are engaged with each other. For this reason, the distance by which the first cam 55 and the second cam 56 overlap each other in the axial direction of the heating roller 35 is set to be short in a second state. The levers 55a and 56a and the pins 58a and 58b rotate from the positions of FIG. 2B and move to the positions of FIG. 1B. In this case, one axial end of the heating roller 35 moves from a position indicated by a dashed line 35a of FIG. 1B to a position indicated by 35b. The line Lb described with reference to FIG. 2A moves to a lower side of the drawings. That is, the heating roller 35 moves from a line Lc to a line Lb. As described above, the first cam 55 and the second cam 56 function as a ring separating/contacting unit separating the guide ring from the fixing belt and bringing the guide ring into contact with the fixing belt.

FIG. 1C is a diagram schematically illustrating the relationship between the fixing belt 34 and the guide ring 40 in the state of FIG. 1A. The guide ring 40 moves in the right direction of the drawing, and thus a spacing is formed between the guide ring 40 and the fixing belt 34. For this reason, the “wrinkle” of the fixing belt 34 is eliminated. As described above, the guide ring 40 is configured so as to be separated from one end of the fixing belt 34, and as a result, the fixing belt 34 can be prevented from being damaged.

As described above, in the embodiment of the invention, the belt fixing device structurally has the following features: (1) a mechanism for releasing (reducing) tension of the fixing belt 34; and (2) a mechanism for separating the guide ring 40 when tension of the fixing belt 34 is released. The belt fixing device further has the following features described below: (3) a storage unit for storing temperature data when the fixing belt 34 has stopped; and (4) a control unit for adjusting tension of the fixing belt 34 on the basis of temperature data stored in the storage unit.

In the embodiment of the invention, control of the belt fixing device is divided into (1) an operation to release (reduce) tension of the fixing belt 34 and to give tension to the fixing belt, and (2) an operation to separate the guide ring 40 from the fixing belt 34 and to bring the guide ring 40 into contact with the fixing belt 34.

(1) Example of Tension Release of Fixing Belt

a) when the fixing belt 34 is cooled (temperature detection: for example, 140/100/60° C.) while a sleep mode (power save mode) is being executed

b) before the fixing belt 34 starts to be driven, when the temperature of the fixing belt 34 is lower than a predetermined temperature (for example, 100° C.)

c) before the fixing belt 34 starts to be driven, when a difference in temperature of the fixing belt 34 between when the fixing belt 34 has stopped and immediately before the fixing belt 34 is driven (for example, 80° C.).

The temperature of a) to c) is the temperature when the fixing belt 34 has stopped, and are detected by the sensor 48 described with reference to FIG. 6. The detected temperature is stored in a storage unit described below. A control unit is provided to control the belt tension adjusting unit on the basis of the temperature of the fixing belt 34 at the time of stoppage stored in the storage unit.

When tension of the fixing belt 34 is released, the following can be executed.

d) The operation to release tension of the fixing belt 34 may be executed multiple times at a time (for example, when the temperature of the fixing belt 34 is low or when the difference in temperature of the fixing belt 34 between when the fixing belt 34 is heated and when the fixing belt 34 has stopped is large).

e) When tension of the fixing belt 34 is being released, the heating roller 35 may be heated. In this case, the number of repetitions of tension release of the fixing belt 34 when the heating roller 35 is heated is controlled to such an extent that thermal stress is not given to the fixing belt 34.

(2) Separating/Contacting Mechanism of Guide Ring

a) The guide ring 40 is provided so as to be separated from the fixing belt 34 when belt tension is released and to return to the original position when tension is given again.

b) The operations to release belt tension, to separate the guide ring, to return the guide ring, and to give belt tension are repeatedly performed multiple times in that order.

As described above, while belt tension is being released, if the fixing belt 34 is shifted in the axial direction (rotation), the wrinkle in the fixing belt 34 is uniformized. If such rotation is executed multiple times, the fixing belt 34 can be further prevented from being damaged.

As described above, according to the embodiment of the invention, the ruffles (wrinkles) concentrated at the end portion of the fixing belt 34 can be distributed over the entire width of the fixing belt 34 by releasing belt tension at a time. In a state where belt tension is released, if the guide ring 40 is shifted in the axial direction, the wrinkle (compressive movement) of the fixing belt 34 can be changed to a shift (rotation around the heating roller 35) (the wrinkle can be eliminated). Therefore, a crack can be prevented from being generated in the fixing belt 34 when being driven again.

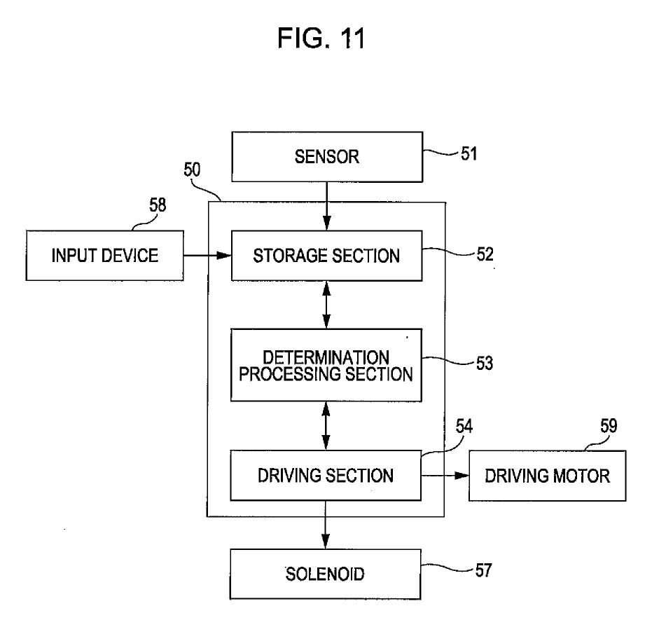

FIG. 11 is a block diagram illustrating the embodiment of the invention. In FIG. 11, a control device 50 of the belt fixing device has a storage section 52, a determination processing section 53, and a driving section 54. An input device 58 inputs, for example, the length in the axial direction of the fixing belt 34 or the heating roller 35. Input information from the input device 58 is stored in the storage section 52. The sensor 51 detects the temperature of the fixing belt 34, and the measurement value is stored in the storage section 52. The sensor 51 corresponds to the temperature detection device 37 for turning on/off the fixing heater 36 of the heating roller 35 described with reference to FIG. 6, and the sensor 48 detecting the temperature of the fixing belt 34 when the fixing belt 34 has stopped.

The determination processing section 53 forms a tension adjustment signal of the fixing belt 34 on the basis of the temperature of the fixing belt 34 at the time of stoppage stored in the storage section 52, and sends the tension adjustment signal to the driving section 54. The driving section 54 controls the solenoid (electromagnetic driving unit) 57 in accordance with the tension adjustment signal. The solenoid 57 corresponds to the solenoid 57 serving as the belt tension adjusting unit described with reference to FIG. 3. The driving motor 59 drives the fixing roller 31 in accordance with a driving signal from the driving section 54. The sensor 51, the storage section 52, the determination processing section 53, the driving section 54, and the solenoid 57 are preferably provided in the belt fixing device or the image forming apparatus. The input device 58 may be connected to the belt fixing device or the image forming apparatus when input information is input to the belt fixing device or the image forming apparatus.

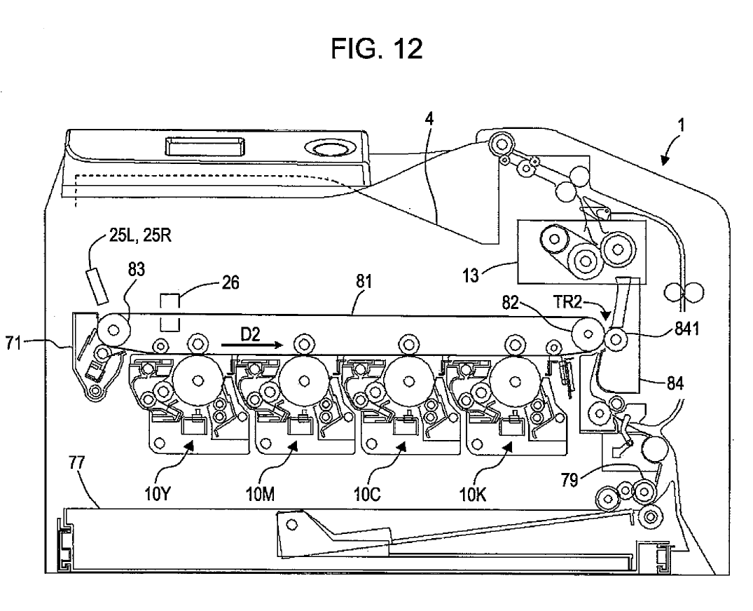

FIG. 12 is a side sectional view illustrating an example of a tandem type image forming apparatus according to the embodiment of the invention. An image forming apparatus 1 forms a color image by combining toner of four colors, for example, black (K), cyan (C), magenta (M), and yellow (Y), or forms a monochrome image only using toner of black (K). The image forming apparatus 1 is a tandem type color image forming apparatus in which four image forming stations 10Y, 10M, 10C, and 10K are arranged along an intermediate transfer belt 81, which is wound around rollers 82 and 83 and revolves in a predetermined direction D2. The image forming stations 10Y, 10M, 10C, and 10K individually store toner of yellow, magenta, cyan, and black, and form toner images of corresponding colors.

When a color image is formed, the toner images of the respective colors formed by the image forming stations are combined with each other on the intermediate transfer belt 81, thereby forming a color image on the intermediate transfer belt 81. A recording sheet, such as paper or a transparent sheet, is taken out from a sheet feeding cassette 77 one by one in accordance with rotation of a sheet feed roller 79, and is transported to a secondary transfer region TR2, which is a nip portion between a secondary transfer roller 841 and the intermediate transfer belt 81. In the above-described manner, the color image formed on the intermediate transfer belt 81 is transferred to a recording medium in the secondary transfer region TR2. The recording medium with an image transferred thereto passes through a fixing unit 13, and is discharged to a sheet discharging tray 4 in the upper portion of the image forming apparatus.

The secondary transfer roller 841 is rotatably mounted in a roller support arm 84. As occasion demands, the arm 84 pivots around a predetermined pivot shaft, and the secondary transfer roller 841 is separated from or comes into contact with the surface of the intermediate transfer belt 81. A vertical synchronization sensor 26 is provided near the roller 83 to detect the rotational phase of the intermediate transfer belt 81. The vertical synchronization sensor 26 is, for example, a photo interrupter, and detects passing of a protrusion or a cutout (not shown) provided in a portion of an edge portion of the intermediate transfer belt 81. That is, the vertical synchronization sensor 26 outputs a vertical synchronizing signal Vsync that is synchronized with the rotation cycle of the intermediate transfer belt 81.

Two position detection sensors 25L and 25R are disposed toward the surface of the intermediate transfer belt 81 wound around the roller 83 at different positions in the axial direction of the roller 83 (a direction perpendicular to the paper). The position detection sensor 25 is, for example, a reflection type photosensor, and detects presence/absence of passing of a toner image carried on the intermediate transfer belt 81 on the basis of a change in reflectance of the surface of the intermediate transfer belt 81 at a position opposite the intermediate transfer belt 81. A cleaner 71 is provided on the downstream side of the position detection sensors 25L and 25R in the movement direction of the intermediate transfer belt 81. The cleaner cleans and removes residual toner stuck to the intermediate transfer belt 81. Although an example of a tandem type image forming apparatus according to the embodiment of the invention is illustrated, the invention may be applied to a rotary type image forming apparatus.

Although the belt fixing device and the image forming apparatus according to the embodiment of the invention has been described on the basis of the principle and the example, but the invention is not limited to the example. It should be noted that various modifications may be made.

The entire disclosure of Japanese Patent Application No. 2008-082293, filed Mar. 27, 2008 is expressly incorporated by reference herein.

What is claimed is:

1. A belt fixing device comprising:
a fixing roller;
a heating roller;
a fixing belt stretched between the fixing roller and the heating roller; and
a pressing roller pressing the fixing roller through the fixing belt,
wherein in at least one end portion of the heating roller in an axial direction, a ring regulating skewed movement of the fixing belt toward an axial end, a belt tension adjusting unit regulating tension of the fixing belt, and a ring separating/contacting unit operating in conjunction with the belt tension adjusting unit to separate the ring from the fixing belt or to bring the ring into contact with the fixing belt are provided.

2. The belt fixing device according to claim 1,
wherein, when the belt tension adjusting unit reduces tension of the fixing belt, the ring separating/contacting unit separates the ring from the fixing belt.

3. The belt fixing device according to claim 1,
wherein the belt tension adjusting unit adjusts an intercenter distance between the fixing roller and the heating roller by an electromagnetic driving unit and a spring unit.

4. The belt fixing device according to claim 1,
wherein the ring separating/contacting unit includes a first cam and a second cam provided at at least one axial end of the heating roller, and each of the first and second cams has a long-distance portion and a short-distance portion in the axial direction of the heating roller.

5. The belt fixing device according to claim 1,
wherein a temperature detection unit for detecting the temperature of the fixing belt at the time of stoppage is provided, and the temperature detected by the temperature detection unit is stored in a storage unit.

6. The belt fixing device according to claim 5,
wherein the belt tension adjusting unit is controlled by a control unit on the basis of the temperature of the fixing belt at the time of stoppage stored in the storage unit.

7. The belt fixing device according to claim 2,
wherein a series of control operation to separate the ring in conjunction with reduction in tension of the fixing belt and to then restore tension of the fixing belt in conjunction with an operation to bring the ring into contact with the fixing belt is repeatedly performed multiple times.

8. An image forming apparatus comprising:
image forming units each having at least one of a charging unit, an exposure unit, a developing unit, and a transfer unit around a photosensitive member; and
the belt fixing device according to claim 1,
wherein the image forming apparatus transfers an image formed on each of the image forming units to a recording medium, thereby performing image formation.
